(19) United States
(12) Patent Application Publication
(10) Pub. No.: US 2020/0023397 A1
(43) Pub. Date: Jan. 23, 2020

(54) DIGITAL PARTICLE EJECTION PRINTING

(71) Applicant: Massachusetts Institute of Technology, Cambridge, MA (US)

(72) Inventors: Anastasios John Hart, Wabon, MA (US); Justin Douglas Beroz, Cambridge, MA (US); Henry Merrow, Brookline, MA (US)

(73) Assignee: Massachusetts Institute of Technology, Cambridge, MA (US)

(21) Appl. No.: 16/212,153

(22) Filed: Dec. 6, 2018

Related U.S. Application Data
(60) Provisional application No. 62/595,391, filed on Dec. 6, 2017.

(51) Int. Cl. B05B 12/06; B05D 1/12; B05B 7/16; B05B 7/22

(52) U.S. Cl. CPC B05B 12/06; B05B 7/228; B05B 7/168; B05D 1/12

(57) ABSTRACT

A particle can be discretely ejected from an orifice in a controlled manner to form a product.

### PRIORITY CLAIM

This application claims priority to U.S. Provisional Patent Application No. 62/595,391 filed Dec. 6, 2017, which is incorporated by reference in its entirety.

### FEDERALLY SPONSORED RESEARCH OR DEVELOPMENT

This invention was made with Government support under Contract No. FA8721-05-C-0002 awarded by the U.S. Air Force. The Government has certain rights in the invention.

### FIELD OF THE INVENTION

The invention relates to digital particle ejection printing.

### BACKGROUND

Direct-write printing has enabled the rapid growth of the flexible and organic electronics industries. However, the spatial resolution of dominant printing technologies such as inkjet is insufficient to fabricate high-performance devices. In addition, printing methods that result in random distributions of solid materials on a substrate limit feature geometry and performance.

### SUMMARY

In one aspect, a printer can include a digital particle ejection printhead including an orifice, an electromagnetic supply configured to generate an electromagnetic field near the exit orifice to eject the particle through the exit orifice, a stage opposite the exit orifice for building a part from the particle, and at least one energy source directed at a space between the exit orifice and the stage or at the stage.

In certain circumstances, there can be 1, 2, 3, 4, 5, 6 or more energy sources. At least one energy source can be directed at the stage, for example, to hit a part or a portion of a part being manufactured by the printer. When directed at the stage, the printer can post-sinter or anneal the part after the particle has been printed.

In certain circumstances, the printer can include a sensor capable of sensing particle condition at a meniscus of a liquid including a particle at the exit orifice.

In another aspect, the method of manufacturing a part can include providing a liquid including a particle to an exit orifice, sensing a condition at a meniscus of the liquid at the orifice, applying an electromagnetic signal near the orifice for timed particle ejection based on the sensed condition to deliver the particle to a surface from the orifice after applying the electromagnetic signal, and applying energy to the particle in flight and prior to delivery of the particle to the surface or upon delivery of the particle at the surface.

In another aspect, a printer can include a digital particle ejection printhead including an orifice, a sensor capable of sensing particle condition at a meniscus of a liquid including a particle at the exit orifice, an electromagnetic supply configured to generate an electromagnetic field near the exit orifice to eject the particle through the exit orifice, a stage opposite the exit orifice for building a part from the particle, and a second printhead oriented to deposit a material on the stage. Optionally, the stage can include a powder bed, for example, of a second material. In certain circumstances, the second printhead can be an inkjet printhead.

In another aspect, a method of manufacturing a part can include providing a liquid including a particle to an exit orifice, sensing a condition at a meniscus of the liquid at the orifice, applying an electromagnetic signal near the orifice for timed particle ejection based on the sensed condition to deliver the particle to a surface from the orifice after applying the electromagnetic signal, and applying a material to the surface from a second printhead. In certain circumstances, the particle can be a pharmaceutical particle. In certain circumstances, the material can be a pharmaceutical additive.

In certain circumstances, the melted particle can solidify once delivered to the surface

In certain circumstances, the energy source can include a photonic source, such as a laser.

In certain circumstances, the printer can further include a second printhead, such as an inkjet printhead.

In certain circumstances, the digital particle ejection printhead can include an array of print nozzles.

In certain circumstances, the stage can be a three-dimensional control stage. Optionally, the stage can include a temperature controller.

In certain circumstances, the printer can include an channel for feeding the particles to the meniscus. For example, the channel can be inclined relative to the stage.

In certain circumstances, the printer can also include a vision system oriented to view the stage. The vision system can also be oriented to view one or more of the printhead, and space between the printhead and the stage. For example, the vision system can be oriented to view at least one of the stage, the printhead, or a flight path of the particle.

In certain circumstances, the applied energy can be heat.

In certain circumstances, the applied energy can melt the particle in flight.

In certain circumstances, the melted particle can solidify once delivered to the surface.

In certain circumstances, the part can include a metal, ceramic or polymer.

In certain circumstances, the method can include selecting the structure and composition of the part by selecting a size of the particle, material of the particle and the energy applied to the particle.

In certain circumstances, the method can include applying a material to the stage from a second printhead.

In certain circumstances, the stage can include a powder bed.

In certain circumstances, the particle can be a metal, a ceramic, or a glass. In certain circumstances, the material can be a metal, a ceramic, a glass, or a plastic. In certain circumstances, the particle and the material can be different compositions.

In certain circumstances, the part can be a two-dimensional part or a three dimensional part, for example, a dental device or jewelry.

In certain circumstances, the method can include selecting a shape of the part.

In certain circumstances, the part can be a drug product, for example, a tablet.

In certain circumstances of the method, the second printhead can be an inkjet printhead.

In certain circumstances of the method, the stage can include a powder bed.

In certain circumstances of the method, wherein the second printhead can include a laser that applies energy to the stage.

In certain circumstances, the printer or method can include a second printhead. The second printhead can be oriented to deposit a material on the stage.

In certain circumstances, the particle is at least a portion of the manufactured part. The printed particles can form the entire part, or a portion of the part. Alternatively, the printed particle can modify a structure or composition of a part when added to the part.

Other aspects, embodiments, and features will be apparent from the following description, the drawings, and the claims.

### BRIEF DESCRIPTION OF THE DRAWINGS

FIG. 1 shows a system for controlling a digital particle ejection printer.

FIG. 2A depicts Digital Particle Ejection (DPE) technology that ejects individual solid microparticles from the carrier liquid by application of a voltage pulse, resulting in deterministic placement and resolution. FIG. 2B depicts, for comparison, inkjet technology that generates droplets by applying a mechanical pressure pulse to the carrier liquid, which causes a stochastic number of nanoparticles to be encapsulated, with random final organization due to droplet spreading.

FIG. 3 depicts an approach of combining a DPE printhead and a second type of printhead.

FIG. 4A depicts a DPE printer system. FIG. 4B depicts a graph showing estimates of melting of a 100 micron stainless steel particle with a commercially available laser (100 watts, 200 micron spot diameter), suggesting that the melt-in-flight concept is feasible given the demonstrated ejection speed and tip-substrate distance in DPE experiments.

FIG. 4C depicts a plot of estimated power requirements for melting platinum, stainless steel, and lead-free solder based on observed particle ejection speeds and a 1070 nm wavelength laser, showing that the melt-in-flight concept is practical for a range of particle materials. The dashed line shows the power level of the fiber laser used in the initial experiment setup.

FIG. 5 shows is a graph depicting the price density of manufacturing and industry products increases with complexity, identifying a space for DPE's unique capabilities to command a high value.

FIG. 6A depicts a jewelry manufacturing workflow. FIG. 6B depicts the finishes of jewelry items.

FIG. 7A depicts dental item workflow. FIG. 7B depicts finishing of dental products.

FIG. 8A depicts an experimental setup that features high-speed video synchronized with precision electrical control and measurement for studying and controlling particle ejection. FIG. 8B depicts validation of the DPE process by experiments ejecting individual 6 μm polystyrene particles, as well as rows and towers of silver-coated 75 μm microspheres. FIG. 8C depicts an experimental set up for characterizing the parameter regime for particle ejection through a set of experiments involving a pressure-controlled water droplet between parallel plate electrodes. FIG. 8D is a graph depicting results plotted in the coordinate system of a dimensionless electric field parameter ΠΦ/γ vs. a dimensionless water droplet parameter Vdrop/R³drop indicate a delineation between particle ejection (black circles) and non-ejection (white circles).

FIG. 8E depicts an approach to quasi-continuous printing, in which particles are fed to a channel upstream of the meniscus. The particles are then driven by gravity towards the meniscus as particles print.

FIG. 9A depicts an experimental setup for ejecting individual particles by the DPE.

FIG. 9B depicts a schematic of the experiment setup.

FIG. 10 depicts a pharmaceutical tablet.

FIGS. 11A-11B depict light microscope images of example 2D patterns printed with DPE and in-flight melting. FIG. 11A shows 150 μm solder SAC305 particles printed in a line, with particles printed one after another with 125 μm pitch (thus 25 μm overlap).

FIG. 11B shows the same solder SAC305 particles printed in another line, though in this case the particles were first printed with 250 μm pitch such that they were not touching, then the space in between the particles was filled with another particle. Both examples demonstrate that the particles can be fused together to form a continuous line.

FIG. 12 depicts images taken from the high-speed camera during experimentation showing ejection of a 100 μm platinum alloy particle; controlled detachment of the liquid remaining on the particle after ejection by heating the particle to induce film boiling between the particle and the liquid; heating and melting of the particle in-flight with a laser beam; and landing and solidifying of the molten particle.

### DETAILED DESCRIPTION

On-demand production, especially for parts with complex geometries and/or high-value material requirements, would be significant to many industries. Additive manufacturing (AM) processes broadly aim to enable this; however, state-of-the-art methods cannot achieve the dimensional resolution and surface finish required for precision applications such as dental implants and jewelry, unless extensive manual post-processing is applied. Production of metal components with customized and/or complex geometries is a longstanding manufacturing challenge. Current processes (including additive methods) can be highly labor intensive for small volumes of precision components, or can require high capital investment for large volumes. For example, dental laboratories and jewelry making exemplify markets that produce products primarily of this type (small, detail-oriented and individually tailored and/or designed). A key value proposition in advancing the approach to making products in these technology areas relates to automating customized production. Both exemplary industries face similar challenges in producing customized items for individual clients and delivery of value to the customer can be highly time-sensitive and design-driven.

For example, the jewelry manufacturing industry ($8 bn U.S. market, $5.1 bn manufacturing precious and semi-precious metal items (see, for example J. Madigan, “Gold washed: Rising import penetration and volatile input costs will limit revenue growth Jewelry Manufacturing in the US About this Industry,” no. February, pp. 1-37, 2017, which is incorporated by reference in its entirety) specializes in customized individual items such as earrings, pendants and engagement/wedding rings. When purchasing custom jewelry, e.g. an engagement ring, the customer typically works with a jewelry designer in-store to determine its appearance, material and size. Afterwards, the designer creates a software model in a computer-aided design (CAD) program and then creates a plastic replica using a 3D printer, or sketches the design and carves a wax replica by hand. The replica is then submerged in plaster and baked in a furnace, where the replica evaporates leaving a cavity (i.e., investment casting). Molten precious metal is poured into the cavity and left to cool before dissolving the plaster in a chemical bath. After this casting process, the item's surface is rough, so a specialist must file, grind and polish the ring until it has the correct dimensions and surface finish. Special grooves and holes are then cut to hold precious stones, which are then set by another specialist in the shop. The turnaround time for this entire process is 2-6 weeks depending on the item's complexity. This can limit the number of jewelry items a designer and related staff produce, is costly due to lack of scalability, and limits the revenue of jewelers as well as the overall market appeal of custom jewelry.

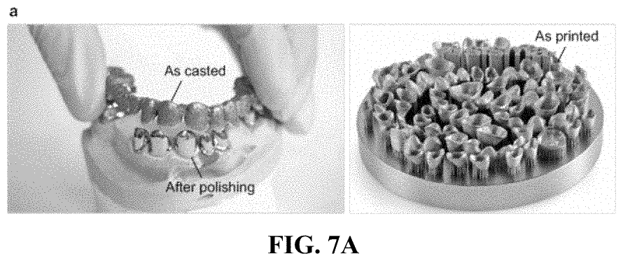

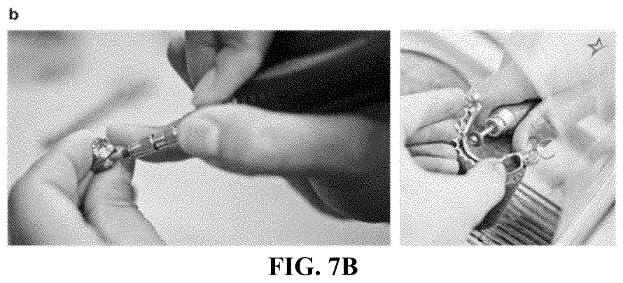

Similarly, the dental laboratory industry in the U.S. ($5.2 bn market (see, for example, K. Oliver, “Molding success: The industry will use new technologies to lower costs and bolster revenue Dental Laboratories in the US About this Industry,” no. December 2016, pp. 1-30, 2017, which is incorporated by reference in its entirety)) specializes in manufacturing implants, crowns, bridges, veneers, onlays, etc., which are each custom products for an individual patient. Digital mouth scans (traditionally, impression molds) of the patient's teeth can be performed at the dentist's office and converted into a CAD model. The workflow is shown in FIG. 7A and finishing is shown in FIG. 7B. Referring to FIG. 7A, dental items such as metal crowns and copings are fabricated at dental laboratories which fabricate metal items by casting or selective laser melting 3D printing, which results in poor surface quality and dimensional resolution. Referring to FIG. 7B, these items are typically finished individually by hand. The model is then sent to a dental laboratory, which fabricates the required product and ships it back to the dentist. These products are fabricated from metal and porcelain using the same casting and manual finishing processes described above for jewelry, resulting in high cost ($100's per part) and long lead time (several weeks). Creating the mouth model (e.g., a digital scan) and performing the implant procedure require minimum two dentist visits from the patient, who must make do with temporary solutions in between. The multiple visits also limit the number of patients the dentist can see, and corresponding financial revenue.

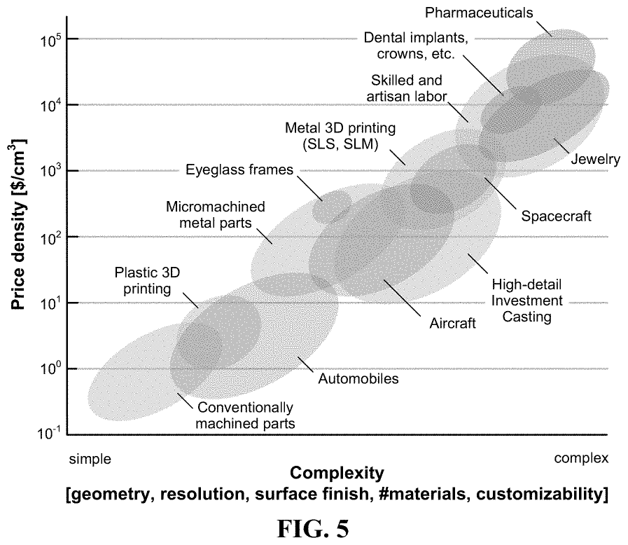

Speaking more generally across industries, the price density of fabricated parts (i.e., the sales price per unit volume) increases with part complexity (a qualitative measure capturing the part's geometry, resolution, surface finish, customization, number of materials) as illustrated in FIG. 5. Referring to FIG. 5, location for products has been estimated in several select industries (dark ovals), which approximately overlay the fabrication methods used (light grey ovals). The highest complexity parts (three upper left ovals) include dental and jewelry, and overlay skilled/artisan labor, which has the highest price density due to high salaries and slow output rate (compared to automated methods).

The digital, particle-oriented, 3D printing technology, called Digital Particle Ejection (DPE) described herein can permit the automated fabrication of parts with complex shapes, smooth surface finish and fine details that are suitable for direct use in jewelry and dental applications. In brief, the DPE technology includes a novel printhead that ejects individual microscale metal particles from an orifice. The particles can be melted in flight by exposure to heat energy, for example, a laser, and they melted particles then solidify upon landing. The item is thereby built particle-by-particle. DPE printing can use any particulate feedstock including metals, ceramics, and polymers, and is therefore compatible with existing supply chains for powder materials.

DPE printers can be used for on-demand production of dental crowns and bridges in the dentist office within 10-20 minutes, with high dimensional accuracy and finish so that the items are ready for installation in the patient's mouth directly out of the printer during the same office visit as the diagnosis. This can reduce or eliminate the long lead-time and high cost of ordering products from a dental laboratory, as well as the need for multiple patient visits and temporary dental appliance solutions. This can be a key value proposition for dentists because DPE printed dental products can (1) provide an in-office capability that greatly improves the patient experience and treatment, and (2) allow dentists to provide care to more patients at cheaper operating costs with direct oversight of manufacturing.

Similarly, DPE printers can be used to manufacture custom jewelry items directly printed with professional-quality mirror finishes or programmable textured surfaces. In addition, the print resolution can be sufficient to include all grooves and holes at the time of manufacture so that the items are ready for gem setting directly out of the printer. These qualities reduce or remove the excessive time and/or labor-intensive casting and finishing procedures so that custom jewelry items can conceivably be designed, fabricated and delivered same-day or next-day, and have intricate 3D and multi-material patterns that are currently impossible to manufacture (for example, gold and platinum weave patterns on a ring's surface). This is a key value proposition for jewelry manufacturers because it will enable (1) reduced lead time and greater design possibilities which improve the customer experience, as well as enable (2) labor and material savings (direct printing affords ˜100% material utilization).

The above capability is uniquely enabled by the DPE printer because it fulfills a technology gap in current manufacturing processes. The indirect processes currently used in jewelry/dental manufacturing cannot provide the required combination of process simplicity, surface finish, material utilization and speed. As described above, the previous casting process requires weeks. Moreover, material utilization has to be nearly 100% for fabricating jewelry from precious metals (i.e., milling from a stock of gold wastes an infeasible amount). In-office machining technology is also gaining traction; for example, Dentsply Sirona is marketing a multi-axis compact mill (MC X5) to dental laboratories as an alternative to investment casing. However, some post processing is required, this is not compatible with precious metals, and the fabrication speed is insufficient to be suitable as an in-office same-visit solution for the dentist.

Other various 3D printing processes have found applications in dental and jewelry fabrication, yet are importantly distinct from our approach and unable to deliver our envisioned value proposition. Briefly, these processes are:
1. Selective laser melting (SLM), whereby metal is fused layer-by-layer by a laser that is rapidly scanned over a powder bed. SLM has wide application in fabrication of complex metal components, especially for aerospace and medical applications, and notably a recent collaboration between EOS and Cookson Gold led to the first SLM machine for jewelry production. However, SLM gives parts with rough surfaces, requires support structures that must be removed by machining after printing, and requires stringent safety procedures for powder handling. In addition, implementation of SLM with resolution smaller than ˜100 um requires complex optical systems and highly size-classified metal powders.
2. Indirect metal printing followed by sintering, including binder jetting and extrusion of metal-thermoplastic composites. These processes are more suitable for in-office use than SLM, yet are not capable of the material quality (purity and density) required for precious metal jewelry. In addition, the resolution and surface roughness of parts made of these methods (due to limitations in binder spreading and extrusion mechanics, respectively) is similarly limited to ˜100 um which insufficient for our target markets.
3. Direct liquid printing methods, which jet liquid droplets from a nozzle onto a substrate via an applied pressure pulse or voltage pulse (i.e., inkjet and electrohydrodynamic jet technologies, respectively). However, these technologies cannot be used to deposit liquid metals due to the high surface tension of liquid metals and material compatibility issues (i.e., high melting temperatures, materials selection for nozzles, nozzle fabrication, etc.). Inkjet printing of nanoparticulate metal inks (e.g., by the startup company Xjet) followed by sintering is attractive for printed electronics manufacturing, but not for precious metals due to purity and cost requirements.

More generally, the DPE printer provides a platform technology enabling direct printing of customized individual parts with minimal post processing, which can provide currently unattainable automation for high part-complexity industries. Thus, while dental and jewelry industries present strong beachhead markets, other suitable applications include: utilizing DPE to place ultra-miniature surface-mount components onto printed circuit boards (PCBs), print medical implants such as stents, print conductive traces, print complex optics (lenses) directly from dielectric particles, or to print pharmaceuticals with tailored release profiles. For example, a single DPE printer in a hospital can have the ability to take raw powder ingredients and in a matter of minutes produce a pharmaceutical pill tailored to a patient's needs. The DPE printer can support entry into these secondary markets and others.

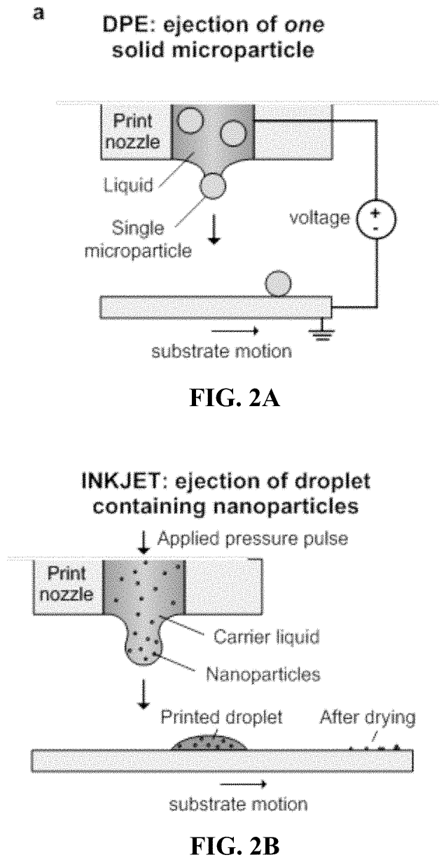

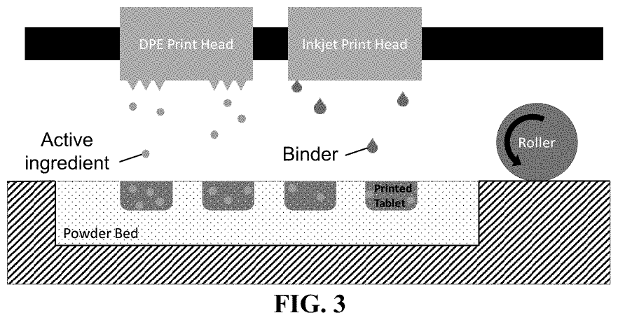

More particularly, the direct-write printing technology, called Digital Particle Ejection (DPE), operates by ejection of individual particles from a confined liquid meniscus at the orifice of a print nozzle. For each DPE printing event, an electrical voltage pulse is applied to the meniscus which in turn deposits exactly one solid particle onto a substrate (FIG. 2A). Experiments show that DPE can eject particles in the 1-100 μm size range, which is suitable to address target applications. For example, ˜10 μm powder particles can be delivered for high-value metal printing of jewelry and dental laboratory items. Common materials (for example, metal, ceramic, glass) can be widely available as dry powders within this particle range. The powders can be easily made in large scale by atomization, mechanical grinding, or chemical synthesis.

DPE is described, for example, in U.S. patent application Ser. No. 14/562,631, which is incorporated by reference in its entirety. The physical principle for DPE is that the applied voltage pulse causes accumulation of electrical charge on the meniscus, and thereby a downward force. Particles adsorbed onto the meniscus are consistently and repeatedly ejected one at a time from the apex of the electrified meniscus. This is because the electrical stress is applied directly to the particles and can overcome the surface tension retaining them on the meniscus. The electrical stress is highly concentrated at the apex, so it is sufficiently strong to eject only the single particle at this location.

DPE was created after surveying a wide spectrum of printing processes (Appendix 1) which found that no method exists to print solid particles across the 1-100 μm size range, therefore current technology cannot directly print 2D and 3D objects from metal and ceramic materials having this level of accuracy and surface detail. The closest established technology is inkjet printing (exemplified in FIG. 2B), where pressure pulses eject microscale liquid ink droplets from a printhead. As a result of using the liquid ink, inkjet printing is primarily suited to printing of patterns (for example, the liquid ink can form thin traces and images on surfaces). The inkjet method of operation requires carefully formulated inks with low viscosity, which are only achievable with nanoparticles (which must be ˜100× smaller than the microchannel and nozzle) at low concentration (up to only ˜5% by volume) with chemical stabilizers (see, for example, B. Derby, “Inkjet Printing of Functional and Structural Materials: Fluid Property Requirements, Feature Stability, and Resolution,” Annu. Rev. Mater. Res., vol. 40, no. 1, pp. 395-414, 2010, which is incorporated by reference in its entirety). Inkjet is not well-suited for 3D metal printing because most of the printed volume is liquid that must be evaporated. A similar competing technology is electrohydrodynamic (EHD) printing which ejects 1-10 μm liquid ink droplets from a printhead by an applied voltage pulse, and is constrained by the same ink property limitations. The DPE printhead is distinct because it involves the ejection of individual solid microparticles. The closest alternative technologies include robotic pick and place machines, used primarily in printed circuit board assembly, which do not have the dexterity to handle these individual particles (e.g., the pick and place approach can be used to manipulate ˜0.1-1 mm or larger objects only).

Direct-write printing has enabled the rapid growth of the flexible and organic electronics industries, and supported many printed products and graphics; however, the spatial resolution of dominant printing technologies such as inkjet is insufficient to fabricate high-performance electronic devices. As a result, additional processing steps are used to increase printing resolution while sacrificing device density, further miniaturization and cost-reduction is limited, and the opportunity to print functional materials from a growing library of colloidal inks is not fully realized. To resolve these problems, Digital Particle Ejection (DPE) can be used for high-speed digital printing. DPE can print virtually any solid object capable of being suspended in a liquid, spanning from nanometers to micrometers in size. These objects could be particles of polymers, metals, or ceramics; intricate chemically made crystals; or miniature chiplets containing lithographically fabricated devices. DPE can print within the 0.1-100 μm size range, and print in particles single (two dimensional) or multiple (three dimensional) layers with controlled arrangements.

The DPE printing mechanism can permit control of part build rates as a function of particle size, particle material, and controlled voltage, part shapes and part material properties, such as density and microstructure.

The DPE printer can be combined with additional fabrication processes on the same build platform. For example, additional materials can be deposited by inkjet, extrusion 3D printing, electrohydrodynamic (EHD) printing, or other methods such as, for example, by binding or fusion of a powder bed. The additional process can enable multi-material printing and encompasses printing of particles, liquids, droplets or extruded materials. The part that is created can have two dimensional patterns that can be printed onto surfaces, droplet-by-droplet. These include patterns of individual non-touching droplets, as well as patterns of contacting droplet which can function as printed lines/traces/areas. The droplets can include only liquid, or optionally contain one or more particles in a liquid. The particles in the liquid can be metal, ceramic, glass, gel or plastic. The particle size distribution of the particles in the liquid can be mono- or multimodal. The part can have a three dimensional pattern built droplet-by-droplet. The pattern of deposition may be layer-by-layer. The liquid may optionally include soluble chemicals such as precursors for the formation of metals, ceramics, glasses, gels or plastics (for example, a precursor can be converted during exposure of a photonic/thermal source during and after deposition).

The DPE printer can be used to manufacture parts of various sizes. For example, the DPE printer can manufacture parts from tens of microns in size, to hundreds of microns in size, to millimeters in size, to centimeters in size, to decameters in size, to meters in size. For example, the part can be 10-1000 microns, 1-10 millimeters, 1-10 centimeters, 1-10 decimeters, or 1-10 meters in size.

By building the parts by particle deposition, three-dimensional parts can be built without support material and can reduce or eliminate waste material. By re-orienting the part during manufacture using the multi-axis stage, support structures can be eliminated. The stage can be a two-dimensional control stage or a three-dimensional control stage, for example, having up to six degrees of freedom, including translations and rotations. In certain circumstances, the stage can have a minimum of three degrees of freedom. The approach also manufactures parts with controllable and high surface quality for the entire part, having minimal roughness and part sizing accuracy down to dimensions of the particle size used to build the part.

Digital particle ejection (DPE) printing technology represents the capability to deposit solid micro objects on-demand, such as individual micro-scale powder particles. Deposition is accomplished by the ejection of individual particles adsorbed on a confined liquid meniscus at the orifice of a print nozzle by application of a controlled voltage pulse. A DPE printer can be used to manufacture objects that cannot be manufactured using other techniques. For example, a DPE printer can be used to manufacture fine metal objects or medical products, including implants and pharmaceuticals.

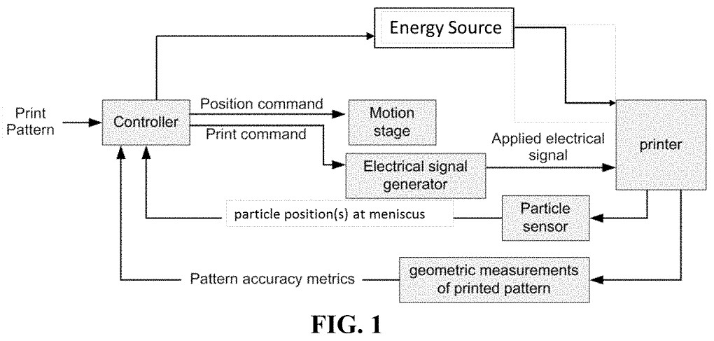

Referring to FIG. 1, a system including a DPE printer can include a particle printhead and an optional energy source. The energy source can be part of the printer. The particle printhead can include a particle sensor. The particle sensor can be, for example, an electrical sensing probe or machine-vision camera. The particle sensor can indicate to the controller when a particle is in the proper location near the liquid meniscus. The controller responds by sending a print command to a signal generator, which outputs an electrical signal pulse to eject the particle. The motion stage repositions the substrate accordingly. Metrics related to the accuracy of the printed pattern may also be recorded by a device such as a secondary optical system, and fed back to the controller if necessary for adjustment of process parameters affecting particle trajectory and substrate registry.

When present, the energy source can be oriented to apply heat to the particles in flight after ejection from the printhead and before impacting the surface. The heat source can include a laser. The power density of the laser can be between 10 and 300 Watts, for example 80 to 120 Watts. The heat source applies energy to melt each particle in flight.

The printhead can optionally include an inkjet printhead for depositing other chemical components before, during or after depositing the particles.

The particle printhead can include a single print nozzle, or an array of print nozzles.

The particles can be fed with particles for delivery from a single source to one or more nozzle. In certain embodiments, there can be a plurality of particle sources, each of which connects to a single or group of nozzles. When multiple sources are available, a plurality of different particle compositions or sizes (or both composition and size) can be printed to form one part.

The particles can be any solid material, including organic material, metal, ceramic, glass or plastic. The surface chemistry of the particles can be modified, if necessary, to provide a surface that is minimally wetting or non-wetting, whereby submerged particles nearby the meniscus of the liquid will spontaneously adsorb onto it.

The DPE printer can be used to deliver particles from a reservoir of particles to the meniscus at the print nozzle. The printer can include a channel connecting to the print orifice that delivers particles. The particles can be submerged in the liquid or adsorbed to the liquid meniscus in the channel. In certain embodiments, electric fields can be applied and fluid flow can be arranged to direct particles onto the meniscus at the print nozzle from a connection channel.

In certain embodiments, the reservoir of particles can include a hopper of particles that connects to the printhead by a channel, for example, a tube. The particles can be, optionally, in dry powder form, or suspended in liquid, or formulated in a slurry. The reservoir of particles can be a replaceable cartridge similar in form factor to an inkjet ink cartridges that can be inserted insert into the printhead. The cartridges can be disposable or refillable, and contain particles in dry powder form, or encapsulated or suspended in a liquid.

When the particulate includes a pharmaceutical ingredient, for example, a particulate active pharmaceutical ingredient (API), the DPE printer can be part of an integrated system for fabricating pills, tablets or capsules. Additional integrated system components can optionally include one or more of the following components: a mechanism to continuously supply particles to the print nozzles during printing, a powder bed for instance comprising a passive ingredient, an inkjet printhead for printing binder liquids onto the powder bed and particles after DPE printing, a powder compression method, such as, for example, a roller or stamp, a capsule holder, or an electronics and vision system for monitoring API particle count and placement. The printhead can be a component of a continuous assembly line, or the entire system may be a single unit that is room-sized or desktop sized which outputs tablets or capsules that are complete, or partially fabricated to include the printed API particulates.

For pharmaceutical purposes, the system can have one or more of the following capabilities. In certain circumstances, the method to print particulates may be a DPE printhead that prints active pharmaceutical ingredients (API) that are in particulate form. More broadly, alternative methods to print individual or small clumps of particulates may also be envisioned. In one approach, single or multiple (for example, using a multi-material DPE printhead, API particles can be printed particle-by-particle onto a target to become part of a deliverable drug. The number, arrangement, size, and material of the particles may be prescribed per target location to enable on-demand and customized pharmaceuticals. Each particle may be counted and its target location can be measured, which can improve accuracy and consistency in drug dosage and release profile.

Using this system, the API particulates can be printed onto a target as part of a process to create the following dosage forms:
a. Tablets, which are compressed powders of API and non-active fillers. The system architecture can result in a method in which API particles are printed into specific arrangements in a filler powder bed, and then converted into solid tablets optionally by pressing or binding. Binding methods can include liquid binders printed by inkjet and/or heating treatments using, for instance, a laser or oven. The tablets can have a graded density, established porosity or other structure determined or programmed by the manufacturing method. The filler, binder or structural material for the tablet may also be 3D printed by other methods, such as inkjet or fused deposition modeling (FDM). The DPE printhead prints the API particulates at programmed positions within the volume of the tablet during its construction. The specific arrangement of API particles per tablet can result in controlled and customized drug release profiles which can be programmed per tablet, or per set of tablets for an individual person. Alternatively, the tablet itself may have a complex 3D shape that may be programmed per tablet, and the location of API particulates defined within the volume may be programmed per tablet.
b. Capsules, which are dissolvable containers filled with a powder or jelly that contains the API. The DPE printer can print individual API particles inside open capsules, which are then closed. The specific arrangement of the API per capsule enables controlled and customized drug release profiles which can be programmed per capsule, or per set of capsules for a particular person.

In the pharmaceutical product, filler materials into which the API particles are printed can be solid or semi-solid such as a gel. In certain circumstances, the filler material itself can be printed by the DPE printhead. Doing so can create a desired drug release profile or mechanical property of the tablet or capsule during its manufacture. The particles used in the manufacture of pharmaceutical products can have various shapes, including spheres, rods, cubes, plates, and irregular shapes. In certain embodiments, the individual tablets and capsules can be printed in less than 10 seconds each, or faster if a multi-nozzle DPE printhead is employed.

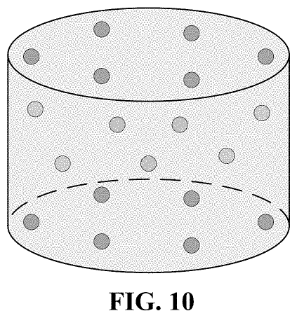

An example of a tablet made by DPE is shown in FIG. 10, which includes depicts a non-active filler material, within which a specific number, type, and arrangement of active ingredient particles can be placed by the DPE printhead.

In another aspect, the DPE printer can be an on-demand heat-in-flight printer. The DPE printer can include a printhead and a heat source. The heat source can be a photonic source, for instance a laser beam that traverses the particle flight path, thereby enabling the particles to be subject to the heat source or photonic source in flight. The DPE process can therefore print dry particulates or molten droplets, and the capabilities of each are detailed below. This DPE printer can include one or more additional system components, for example, a mechanism to continuously supply liquid and/or particles to the print nozzles during printing; a build platform and motion systems to enable relative motion (position and orientation) between the printhead and object being printed; a temperature controlled environment for printed item, for example a heated build stage and surrounding chamber; and an electronics and vision system for monitoring part accuracy and allowing adaptive corrections. Alternatively, the printhead and photonic source may be incorporated into larger systems, for instance as part of a continuous assembly line.

The DPE printer has one of the following features. For example, the printhead can eject particulates that are dry or in contact with a small volume of liquid not more than the volume of the particle. In particular, the print method can be a DPE printhead that prints individual particulates. Alternatively, the DPE printhead can deliver an individual or small clumps of particulates.

The DPE printer can form two dimensional patterns on surfaces on a particle-by-particle basis. The patter can include individual non-touching particles, or patterns of contacting particles which may function as printed lines/traces/areas. The DPE printer can also be used to form three dimensional parts, built on a particle-by-particle basis. The pattern of deposition may be layer-by-layer, or an intricate deposition schemes, such as an inside-to-outside building of the part.

When present, the thermal energy imparted to a particle by the heat source, for example, the laser. The energy supplied by a laser can prescribed by the on duration of the laser, pulse-width modulation, laser wavelength, and spot size. These parameters may be varied depending on the composition of the particle and the size of the particle. In certain embodiments, the energy supplied can be varied per particle during print. Each particle may be non-heated, heated, softened, partially liquefied, liquefied, or super-heated by the laser. The particle can land on the build platform in any of these states. The print mode of the DPE printer can enable particles with different thermal requirements (for example, melting point) to be printed into the same part.

The photonic source may emit pulsed or continuous wavelength(s) towards the ejected material, such as the droplet or particle, or a combination thereof. The photonic source can be focused to a spot with a diameter larger, equal or smaller than a droplet during flight. The focus spot of the photonic source can be stationary, or might trace the droplet during the flight. The focus spot shape of the photonic source can be any shape (for example, round, rectangular or arbitrary). The photonic source may also illuminate the particle from multiple directions. These parameters can be selected to result in one or more of the following effects:
a. Heating and/or evaporation and/or liquefying of parts or all of the droplet (liquid/solid)—The photonic source can be laser, laser diode, focused infrared beam, IR diode or the like.
b. Melting a component of the droplet.
c. Chemical reaction, phase change, or precipitation of a substance from the droplet—may involve a variety of wavelengths, intensity, and duration depending on the application. In this case, the photonic source can be a laser, or a diffuse light source.

The DPE printer allows new parts to be manufactured due to the unique nature of the DPE process. For example, the DPE printed parts can be made with a single material composition or a multi-material composition. The multi-material composition can be manufactured using a multi-nozzle DPE printhead, or by providing different materials to a single nozzle. The material composition can be varied, graded or otherwise controlled throughout the volume of the part. Examples of part structures that can be accessed include one or more of the following:
a. The interior of a 3D part can be printed using larger particles (˜100 micron) and the exterior using smaller particles (˜10 micron). This combination approach can increase build rate while maintaining a high quality surface finish. In another variation of this concept, the particles in the interior and on the surface may have difference compositions, for example, to save cost by filling the interior of a part with a lower-cost material.
b. 3D parts can be printed with controlled density throughout the volume by fully liquefying particles with the laser. Alternatively, the interior of a part can be porous and include partially heated or non-heated particles to achieve a desired material property such as high toughness or high damping.
c. The prescribed heating per particle can allow for precise control of microstructure, grain size, and material composition of the part. The details of particle material and size, particle landing, and heat treatment of the part during build (i.e., a temperature temperature-controlled stage or enclosure) can also influence final part material properties. Therefore, the heat treatment on the surface and throughout the volume of a single part can be varied depending on design criteria of the part.

The system architecture can be incorporated into a single enclosure that is shop-size, or desk-top size. For example, an outer enclosure can house the printhead and a laser, for example, a laser diode, can be fixed above a compact multi-axis build stage and heated chamber. In certain circumstances, the system can include an electronics and vision system for monitoring part accuracy and allowing adaptive corrections.

The heat source can introduce one or more of the following capabilities to the system when it includes a liquid component, including:
a. Heating a droplet to evaporate liquid. Traditional inkjet heads eject drop volumes as small as ≈1 μL, which is ≈12 μm diameter. By evaporating some of the liquid in a drop the drop volume can be decreased to for example 0.1 pL which is approx. 5 micron diameter. Thus, it is possible to print smaller features previously not possible. If the droplet contains particles, this can create a higher particle density in the droplet before landing, which may exceed the upper limit of particle density required to eject a droplet from the printhead (typical inkjets are limited to 3-10 volume %). The concentration effect can change the viscosity of the droplet upon landing, and can be outside the range required to eject a droplet from the printhead (typical inkjets are limited 8-20 mPas). Simply heating the droplet, with or without significant evaporation, can also change the viscosity. Therefore, heating and evaporating some liquid during the flight allows decoupling of the required properties of the liquid for droplet ejection from the properties of the droplet during and after impact on the substrate.
b. Heating a droplet to enact a physical or chemical change.
   i. Particles inside a droplet may flocculate together or precipitate into a solid. This can happen inside the droplet, or on the droplet's surface, before landing.
   ii. Particles can be created inside the droplet using chemical precursors present in the liquid. Alternatively, particles already present inside the liquid can change size (typical inkjet printheads are limited to particles smaller than about 100 nanometers).
c. Additional photonic sources to modify the composition of the droplet. A droplet of photo-curable liquid can be exposed to a UV light source in flight, causing the droplet composition to gel or solidify. Other photo-initiated processes may modify the droplet in flight.

In certain circumstances, a droplet containing particles may be heated to evaporate all the liquid, leaving only dry particles. Under this condition, the capabilities described herein for a particulate ejector printhead can apply here upon further heating.

Deterministic ejection of individual particles from a random dispersion can be achieved with DPE. The particles can be in a single file inside a structure, such as a capillary tip. The particles can be ejected through a particle funneling or alignment method. The ejection can be due to physical constraint, like a capillary tip, or by an applied field, such as an electromagnetic field.

Electronics and optics can be used for controlling, sensing, and imaging the process. For example, high-precision motorized actuators can be used for programmable positioning of the capillary tip, custom machining can be used to enable exchangeable dispensing tips, and high-speed sensitive electronic circuitry can be used to measure printing process parameters. Hardware components for DPE printing can include a liquid reservoir, dispensing orifice, electrode configuration, and a voltage source. Certain features of the hardware and methods can enable controllable sensing and ejection of individual particles from the liquid meniscus. Microfabricated nozzle arrays can be as printheads for DPE. In contrast, bulky capillary tube delivery systems have been used in multi-tip EHD liquid printers. A method of forming conductive lines can include heating chains of individually arranged particles. DPE can also be used to prepare OLED architectures featuring printed micro-crystals and/or stacked particulate elements.

Key process parameters and attributes (i.e., voltage pulse profile, particle ejection velocity and trajectory, power consumed per print, etc.) can be determined, and derive experimental scaling laws for DPE printing (e.g., speed and voltage versus size and particle conductivity) can also be determined.

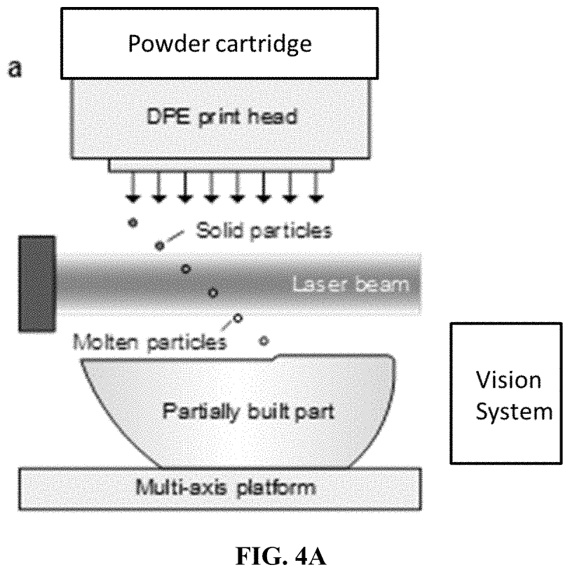

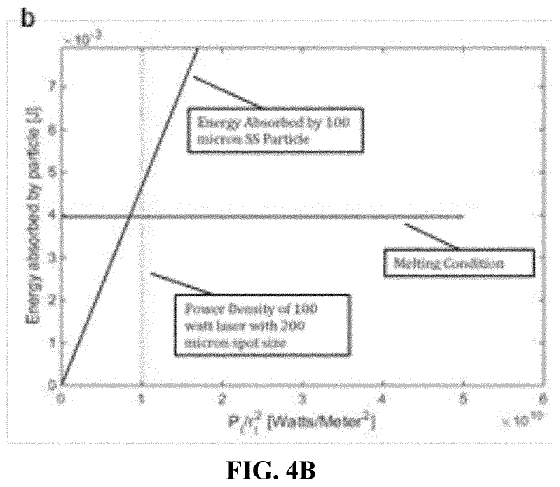

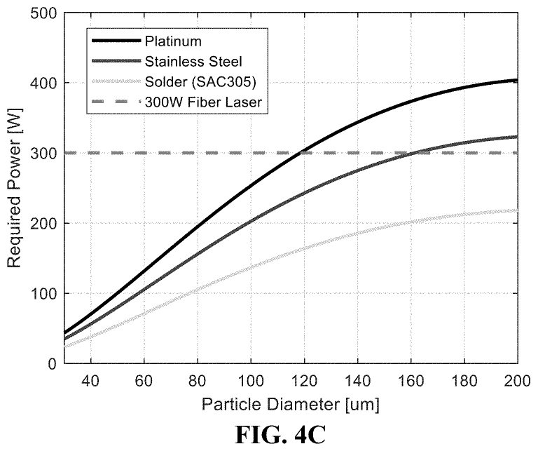

DPE printer can print discrete particulates from 0.1-100 μm, such as 1-μm diameter, from an orifice, such as a glass capillary tip. DPE printer can print discrete particulates from 1-100 μm; DPE printer can print discrete particulates from 0.1-1 μm. DPE can print not only one-dimensional structures, but also two-dimensional or three-dimensional structures. For example, DPE can print metallic particle (˜1 μm) lines and grid arrays, and organic crystals (0.5-50 μm). In addition, DPE can print 1-10 μm wide conductive lines on substrates, by printing individual conductive (metallic or carbon) particles (1-10 μm diameter) in line patterns, followed by an annealing step (i.e., heating) to fuse the particles into solid conductive traces (see, for example, FIG. 4A).

During DPE printing, a condition near the apex of a meniscus of the liquid at the orifice can be sensed. The condition can be an electrical boundary condition and/or a liquid flow boundary condition by near the apex of a meniscus of the liquid at the orifice. The condition can be sensed by detecting the location of the particle near the apex of a meniscus of the liquid at the orifice. The condition can be sensed by measuring electrical properties of the liquid.

During DPE printing, an electromagnetic signal can be applied. The electrical signal can be AC or DC; the electromagnetic signal can be either constant or slowly varying with respect to print dynamics. A profiled electrical signal pulse on the timescale of particle ejection dynamics can be applied and may be or superimposed on the applied electrical signal. A voltage pulse can be applied. An alternative is to apply s constant bias voltage, which can cause repeatable and regularly timed printing of individual particles.

For DPE printing, particles can be supplied in different ways. For example, particles can travel within the liquid towards the meniscus, where it is ejected when sufficiently close. In another approach, a discrete number of the particles can be supplied directly onto the meniscus, from which they are ejected once at the proper location.

The particles can be a solid material, for example, a metal or ceramic, or combinations thereof. The particles can be printed at build rates approaching ˜0.1 cm³/hr per print nozzle with single particle resolution. The process can be parallelized via a multi-nozzle printhead to reach 10-100 cm³/hr build rates (10-100's of nozzles) in a miniature (bench-scale) system or faster for industrial systems. DPE can permit the on-demand production of dental crowns in the same office visit and same day production of intricate custom jewelry designs ready for gem setting. DPE will reduce costs, offer improved customer experience, and enable designs not otherwise possible.

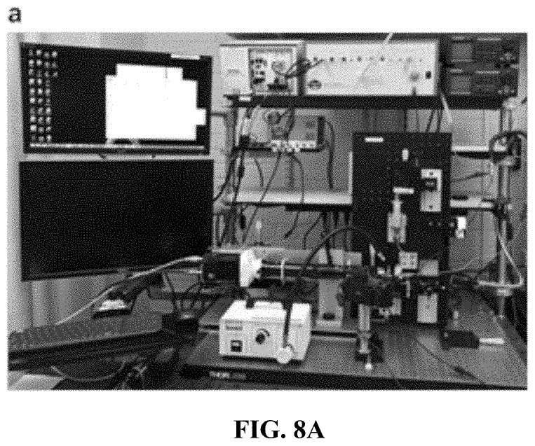

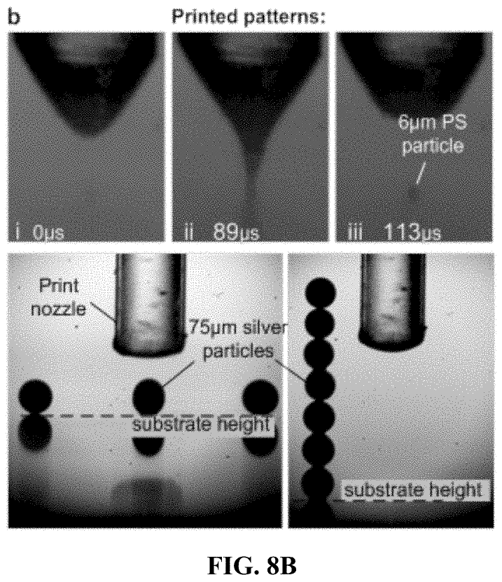

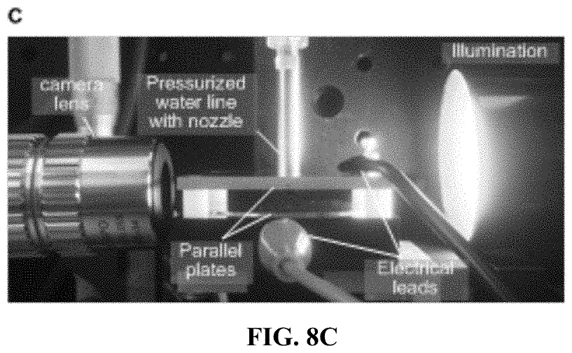

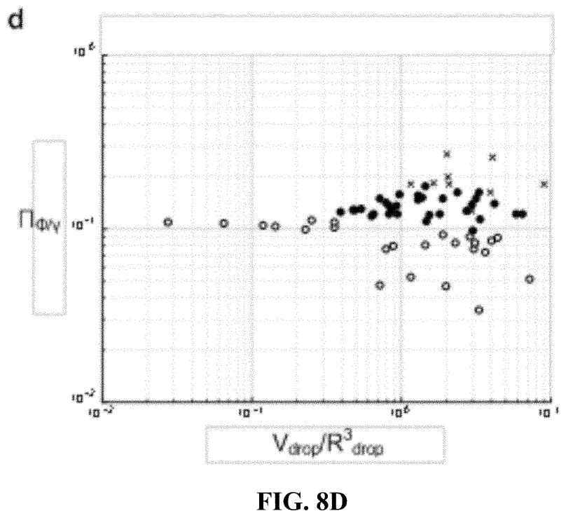

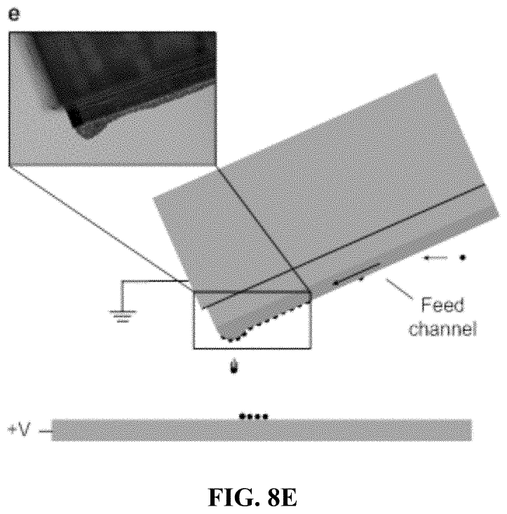

Previously, the DPE concept was demonstrated to be viable by printing individual particles of select materials and sizes into patterns on substrates by applying individual voltage pulses. This approach included deposition of polymer particles less than 10 μm, glass particles, and metal particles printed individually into rows with 1 mm spacing, and into vertical towers which illustrated printability of 3D structures. An apparatus (FIG. 8A) has been constructed which includes a high-speed imaging system synchronized with programmable electrical control and measurement to analyze particle ejection events. Validation of DPE is shown in FIG. 8B.

Through this precision experimentation, it was learned that a particle ejects only when adsorbed on the meniscus, in contrast to being fully submerged in the water. Based on this insight, the force balance on a particle at the meniscus apex is being characterized through a set of experiments involving a pressure-controlled water droplet between parallel plate electrodes (FIG. 8C). The required voltage can depend on the particle size and material properties, as well as the rate of electrical charge accumulation which determines print speeds. For instance, FIG. 8D delineates between particle ejection (black circles) and non-ejection (white circles) within the coordinate space of relevant dimensionless parameters. It is possible to continuously feed micro-particles onto the water meniscus. Experiments indicate that delivering particles via a connecting inclined fluid channel can be one feasible initial solution (FIG. 8E), which would enable a single-nozzle printhead, which may in turn be scaled to a printhead with at least about 10 to about 100 nozzles using arrays of microfluidic channels.

Continuous feed of particles to the meniscus can result using a channel. Particles can be adsorbed on the surface of a liquid meniscus in a channel, and the particles feed from the channel to the location of ejection. The location of ejection can be a single/multiple nozzle(s). Alternatively, ejection can be at particular locations in the channel where the electric field is engineered to be stronger than in other locations of the channel. For example, the channel can be inclined so that gravity assists the delivery of particles from the channel. An electric field or magnetic field can be established inside the liquid at the print nozzle to help guide particles from inside the liquid to the liquid surface for ejection. If the liquid is a conducting liquid, electrical current can establish the electric field. If the liquid is a dielectric liquid, the electric field can permeate the liquid droplet. The electrical force that is used to move particles can be electrophoretic or dielectrophoretic. The particles can be charged or uncharged and optionally magnetic. A Lorentz force can be applied for magnetic particles. Particle movement can also be accomplished by establishing a liquid flow within the liquid near the print nozzle to deliver particles to the liquid meniscus. Another approach to delivering particles to the meniscus is to establish vibrations using acoustic waves within the liquid. In another example, it is possible to introduce particles directly onto the print nozzle meniscus externally. For example, a current of air with particles flows past the nozzle and particles in the stream contact the meniscus and adhere to it. Combinations of these various particle movement techniques can be used.

Extrapolating from these experiments, the rate of particle ejection can be estimated to be ˜0.5 kHz for 30 μm particles, which can convert to a build rate of ˜0.25 cm³/hr. Hence, printing the volume of a dental implant or small jewelry item (˜1 cm³ of solid) is possible in much less than an hour using a small nozzle array (˜10 nozzles) with a common feed tube for the particles. Moreover, a printhead can be configured to build the interior of a part from larger particles (˜100 micron) and the exterior from smaller particles (˜10 micron), thereby combining higher throughput with high surface quality.

To print metals and ceramics for jewelry and dental products, a DPE printer architecture can include a printhead and powder cartridge positioned above a multi-axis build stage with a laser beam traversing the particle flight path (FIG. 4A). Referring to FIG. 4A, to print solid parts, microparticles can be ejected from a printhead (one or many nozzles) which pass through a laser beam, becoming liquefied before landing on the target object. Control of the droplet landing trajectory will allow freestanding structures to be made; as a countermeasure, a secondary support material such as a water-soluble ceramic may be used. The metal particles liquefy as they pass through the laser beam and land, still molten, on the build stage. This allows full-density metal parts to be directly printed with a mirror surface finish because each particle can have a smooth surface from being liquefied. The whole part can be built up particle by particle, utilizing re-orientation with the multi-axis stage to eliminate the need for support structures.

In certain circumstances, each particle can be non-heated, heated, softened, partially liquefied, liquefied, or super-heated by the laser, and also land on the build platform in any of these states.

In certain circumstances, the printed parts may be single or multi-material (using a multi-material DPE printhead, for instance where different nozzles deposit particles of different materials), and material composition may be varied or graded throughout the part. Examples include:

i. The interior of a 3D part may be printed using larger particles (˜100 micron) and the exterior using smaller particles (˜10 micron). This may increase build rate while maintaining a high quality surface finish. The particles in the interior and on the surface may be different materials, for instance to save cost by filling the interior of a part with a lower-cost material.

ii. 3D Parts may be fully dense throughout the volume by fully liquefying particles with the laser. Alternatively, the interior of a part may be porous and include partially or non-heated particles to achieve a desired material property such as high toughness or high damping, or by using multiple materials.

iii. The prescribed heating per particle enables control of microstructure, grain size, and material composition of the part. The details of particle material and size, particle landing, and heat treatment of the part during build (i.e., a temperature temperature-controlled stage or enclosure) also influence final part material properties. Therefore the heat treatment on the surface and throughout the volume of a single part can be varied, as well as the temperature of the particle upon landing so as to influence the cooling rate.

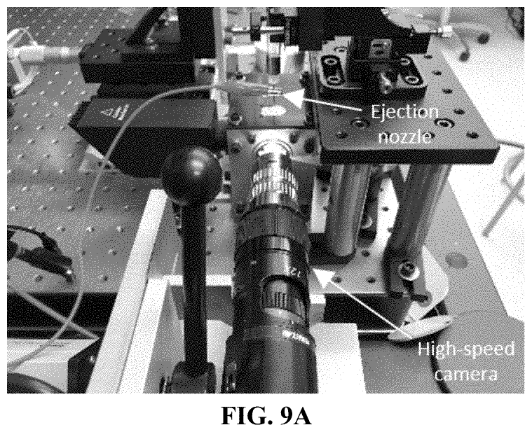

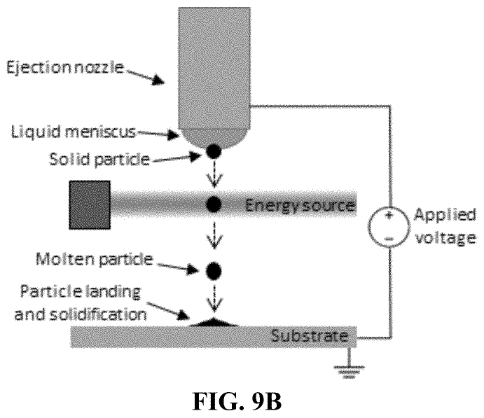

Referring to FIG. 9A, an experimental setup for ejecting individual particles by the DPE method and passing them through a laser beam in flight is shown. Referring to FIG. 9B, a schematic of the experiment setup inside the enclosure of containing the laser beam shows the ejection nozzle and liquid meniscus releasing a solid particle using an applied voltage. Upon passing through an energy source (e.g., laser beam), the solid particle becomes a molten particle, which then lands on a substrate and solidifies.

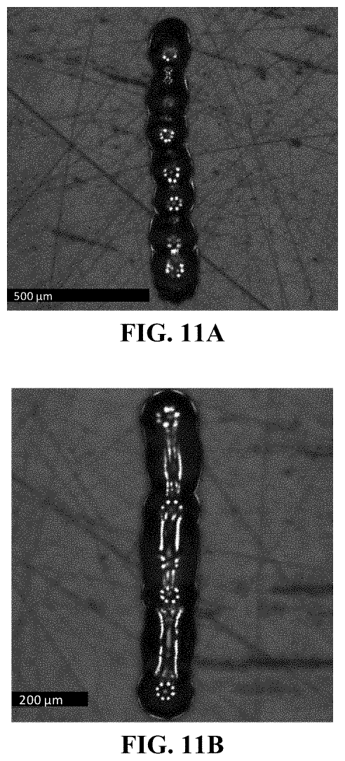

It is possible to melt particles in flight after ejection using commercially available lasers with ˜50-300 W power that are currently used in SLM 3D printers. For melting, the energy absorbed by the particle when passing through the laser beam must be greater than the energy required to bring the particle to its melting point plus the material's latent heat of fusion. Example calculations in FIG. 4C show that metal particles (in this case, platinum, stainless steel, and SAC305 solder alloy) up to 100 μm or greater in diameter can be melted by passing them through a laser beam (300 W, 30 μm spot size) at flight velocities measured in the DPE experiments. The experimental setup described in FIG. 9A and FIG. 9B has been used to successfully melt solder and platinum particles in flight. FIGS. 11A-11B show examples of printed 2D patterns with solder particles. In FIG. 11A, the particles are printed successively with 125 μm pitch, and thus 25 μm overlap. In FIG. 11B, the particles are first printed without touching with a 250 μm pitch, then the spaces between the particles are each filled with another particle. These examples demonstrate that the particles can be fused together to form a continuous printed pattern.

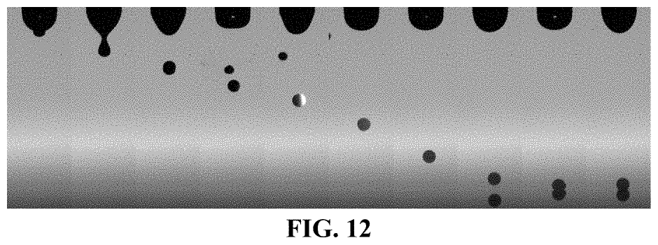

To maintain the desired trajectory of the particles while heating in-flight, the liquid that remains on the particle after ejection should be controllably removed from the particle. This can, for example, be done by adjusting the heating profile such that the liquid on the particle is evaporated, or such that the liquid becomes detached by inducing film boiling on the surface of the particle, resulting in a separation of the particle and the liquid. The detached liquid may be carried away by a gas flow to avoid contamination of the printed part. FIG. 12 shows sequential images of the DPE printing and melt-in-flight process for a single particle, illustrating the controlled detachment of the liquid without altering the flight trajectory of the particle. Besides the heating profile, other important factors that influence the liquid removal process include the amount of liquid on the particle upon ejection, and whether the particle is fully engulfed in a liquid droplet after ejection or mostly dry with a small cap of liquid. These conditions are in part determined by the particle position on the meniscus before ejection, which can be adjusted by tuning the properties of the liquid or by engineering the surface of the particle.

In certain embodiments, a commercial DPE printer can be approximately 2 ft³ in size, and capable of resting on a table top and plugging into a standard wall power outlet (a single U.S. outlet provides far more power than required to run the whole system). An outer enclosure can house the printhead and a laser diode fixed above a compact multi-axis build stage and heated chamber, as well as include the electronics and vision system for monitoring part accuracy and allowing adaptive corrections. The printhead can be fed by a disposable material cartridge containing metallic and ceramic powders optionally encapsulated in a fluid. The disposable material cartridge can be about the same size as a standard inkjet ink cartridge and insert into the printhead in a similar manner. Minimal maintenance can be required because the part is directly printed without support material or residues that require cleaning. The printer could be used without highly specialized training or safety considerations.

The DPE printer and consumables can be directly to users, such as individual dental practices. The dental industry is minimally concentrated and includes mostly small single-practitioner establishments serving local customers. See, for example, K. Oliver, “Open wide: Increased access to dental care and Dentists in the US About this Industry,” no. December 2016, pp. 1-37, 2017, which is incorporated by reference in its entirety. Dentists primarily compete with other local dentists on price and range of services offered, and are quick to adopt new technologies which improve client satisfaction and minimize visit time, which increase client's visit frequency and election of additional services. See, for example, K. Oliver, “Open wide: Increased access to dental care and Dentists in the US About this Industry,” no. December 2016, pp. 1-37, 2017, which is incorporated by reference in its entirety. For instance, digital imaging of patients' teeth has become standard in the last decade for requesting dental laboratory products. Dentists also increasingly use plastic 3D printing in the office to fabricate numerous items including mouth trays, bite guards, surgical guides and replicas to practice surgeries prior to patient visits. See, for example, S. Turk, “Say cheese: An aging population will stimulate industry demand due to age-related tooth ailments Cosmetic Dentists in the US About this Industry,” no. April 2016, 2017, which is incorporated by reference in its entirety. The plastic parts print in a couple hours for a fraction of the cost of ordering from a dental laboratory, and enable dentists to complete more procedures, provide better care and increase profit. Additionally, some dentists have begun using 5-axis CNC machines to manufacture and cement crowns in one visit (Sirona). This illustrates market demand; however, DPE printers can have significant advantages over CNC milling in many aspects including part accuracy, material utilization, and advanced functionality such as multi-material parts which we have learned are highly attractive to the dental industry. Overall, the industry is receptive to new technologies that provide a competitive advantage, and practitioners, as well as dental laboratories, who create CAD models and utilize 3D printers already have the skillset to use the DPE printer technology.

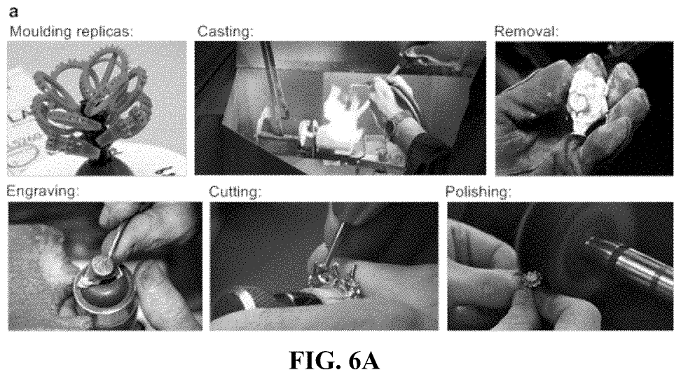

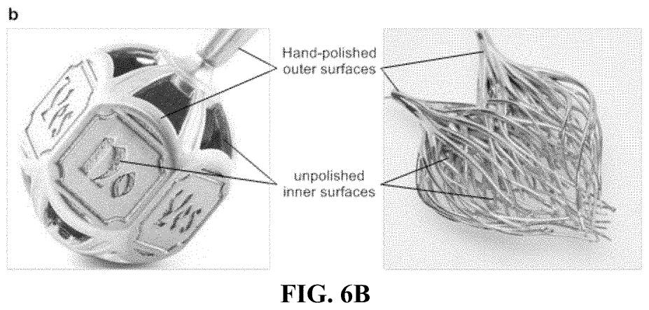

The DPE printer can be sold directly to jewelry manufacturers. This can allow jewelry shops to devote more resources towards jewelry designers working with customers, and fewer resources towards fabrication and inventory. Customers will be able to intimately engage in the design process, sketching ideas with the jewelry designer, and bring home the item same day. A limitless variety of designs can be accessed with the DPE printer with fewer fabrication specialists and reduced material costs due to a digital workflow. Improved personalized service and availability of designs can attract more customers because there is often little differentiation in services and products offered between competitors. See, for example, J. Madigan, “Gold washed: Rising import penetration and volatile input costs will limit revenue growth Jewelry Manufacturing in the US About this Industry,” no. February, pp. 1-37, 2017, which is incorporated by reference in its entirety. Moreover, a small shop can gain flexibility to adapt to highly seasonal demand (i.e., wedding and holiday) with reduced labor capacity, resulting in increased revenue per employee and less wait time for customers. New business models could allow the customer and designer to interact virtually to come up with a design which is then digitally produced and shipped to them. A typical jewelry manufacturing workflow is shown in FIG. 6A. Workflow for metal jewelry starts by creating plastic models using a 3D printer (alternatively, a designer/artisan creates a wax model of a design by hand). These are replicated in metal by investment casting, i.e., submerged in plaster and baked in a furnace to create a hollow ceramic, which is then poured with molten precious metal. After removal of the ceramic shell, the ring's surface is rough, so a specialist must detail and polish the ring by hand. Referring to FIG. 6B, in finished items, outer surfaces can have smooth reflective surfaces, however unreachable internal surfaces and crevices are left unpolished. The jewelry industry can be receptive to new technologies: in the last decade software modeling and plastic mold 3D printing were widely adopted, and a collaboration between EOS and Cookson (a SLM printer company and precious metals supplier) has demonstrated a powder-bed AM process for gold parts. The success of 3D printed jewelry through online stores, such as Shapeways and Etsy, demonstrates consumer interest and the market share for 3D printed jewelry is forecasted to reach $11 bn by 2020. See, for example, “3D Printing in Jewelry Markets Will Reach $11 Billion by 2020.” [Online]. Available: www.forbes.com/sites/tjmccue/2015/09/25/3-d-printing-in-jewelry-markets-will-reach-11-billion-by-2020/#7b716da24b27. [Accessed: 31 May 2017], which is incorporated by reference in its entirety.

Other markets for a DPE printer can include the healthcare industry. DPE printing could enable a new route to on-demand and customized pharmaceutical tablets (FIG. 3). For instance, to print pharmaceuticals, a DPE printer can be used to manipulate individual API (Active Pharmaceutical Ingredient) particles allowing for in-process inspection of particle size and shape, ensuring that the final drug release profile and mechanical properties are as designed. DPE does not rely on individualized formulations of inks and instead prints solids only, making it a more flexible process that is not limited to inks with low concentrations of APIs. Precise placement of individual particles can allow for customized dosages, release profiles, and the potential to combine compatible drugs into a single tablet which can be synchronously produced by inkjet binding of non-active powder. Printing speeds can depend greatly on the nature of the pharmaceutical being printed; however, DPE printing can create printed dosages (for example, tablets) at a rate of less than 10 seconds each and perhaps significantly faster using an industrial system. For example, as shown in FIG. 3, to produce pharmaceuticals tablets it is possible to combine DPE printing (for the API particles) with binder jetting (inkjet+powder bed) to build a surrounding tablet rapidly, anchoring the particles deposited by DPE and providing supporting powder to form the remainder of the tablet. The second printhead can include an energy source. Precise placement of individual particles or groups of particles can allow for customized dosages, release profiles, and the potential to combine compatible drugs into a single tablet, increasing adherence. The powder bed can consist of drug excipients and can be applied layer-wise by a roller or blade mechanism and an inkjet printhead can be used to dispense a binding agent.

In certain circumstances, the specific arrangement of API particles per tablet can be selected to enable controlled and customized drug release profiles to be programmed per tablet, or per set of tablets for a particular person. The tablet itself may have a complex 3D shape that may be programmed per tablet, and the location of API particulates defined within the volume may be programmed per tablet.

In other words, the architecture of a pharmaceutical tablet can be controlled such that API particles are positioned in a tablet matrix, for example, in a regular arrangement which can involve uniform spacing in one or more layers, or varying spacing in three dimensions in the tablet structure.

As mentioned above, the DPE printer can be used in business-to-business relationships. For dental and jewelry markets, the DPE printer can be used by individual practitioners (e.g., dentists, jewelers) who wish to use the technology for in-office production of metal parts, and/or large facilities that already have the customer base and digital workflow in place for acquisition and processing of scan data. Size-classified metal and ceramic powders can be provided as DPE printer feedstocks.

The DPE printer can be scaled into a multi-nozzle printhead. The DPE printer can include a variety of engineering of nozzle arrays, a variety of application-specific material feedstocks (e.g., wet and dry powder cartridges), various software development, and product design and manufacturability. The core DPE printer technology can be integrated into both desktop and industrial equipment. The DPE printer technology can provide functional capability to deposit solid micro-objects, including microparticle powders, with digital resolution on-demand. The DPE printer includes a liquid reservoir, a voltage source, a motion stage, and other components.

The DPE printer includes a continuously-fed single-tip printhead with in-flight melting. The DPE printer can have a selectable print rate, a continuously-fed nozzle, and can print patterns with melting/solidification of particles.

In one aspect, a method can include continuously feeding particles onto the liquid meniscus. As mentioned above, particles can be delivered to the print nozzle via a connecting inclined fluid channel (FIG. 8E). Particles adsorbed onto the liquid surface in the channel can feed onto the meniscus under the print nozzle during a print event. Particles in the channel can experience gravitational and electrostatic forces directed towards the nozzle. Upon ejection of one particle, another particle arrives under the print nozzle via the connecting channel. This approach can provide a robust continuous feed of particles. Alternative approaches can include using metal particles coated with a hydrophobic layer, i.e., an engineered combination of surface material and texture that results in a high surface energy when contacted by the liquid at the print nozzle, that can allow the particles to adsorb onto the meniscus without being completely submerged. A variety of methods have been established for creating hydrophobic surfaces, including, for water-repellant surfaces, (textured) wax coatings, chemical treatment, plasma treatment, vapor deposition, etc.

In another aspect, a multi-nozzle printhead can include a physical architecture with automated control/feedback for timed particle ejection and coordinated substrate motion. The multi-nozzle printhead can be constructed, for instance, out of an array of capillaries or milli-fluidic channels and can use a printed-circuit board for proximate electrodes. In another example, a single nozzle printhead with continuous particle delivery can form an array of printheads.

In another aspect, the DPE printer can be based on particle trajectory precision. The basic physics of ejecting the particle from the liquid meniscus can provide a repeatable initial trajectory for the particle. Various factors including particle charge, topology of a partially printed part, particle heating while passing through the laser beam, and other factors can affect the placement precision of the particles. It is possible to observe the particle flight paths. If necessary, additional electrodes can be used to focus particles trajectories.

In another aspect, metallurgy of rapid solidification of DPE-printed particles can be adjusted to assure the quality of printed parts will relate to their metal microstructure, residual stresses, and surface roughness. The metal properties can be developed from the material science developed for current spray and powder bed metal AM processes, which involve the same basic physics of laser melting and rapid solidification, and show that full metal density can be achieved. In addition, the small (˜cm-scale) size of parts made by DPE can reduce deformation that can form due to residual stresses.

In another aspect, a camera vision system can be used to monitor the dimensional accuracy of parts made by DPE. The DPE printer can include the camera vision system to monitor the dimensions of the part during printing and allow adaptive correction of the part manufacture, such as by changing the subsequent deposition pattern of particles and other process parameters.

Other embodiments are within the scope of the following claims.

What is claimed is:

1. A printer comprising:
a digital particle ejection printhead including an orifice;
an electromagnetic supply configured to generate an electromagnetic field near the exit orifice to eject the particle through the exit orifice;
a stage opposite the exit orifice for building a part from the particle; and
at least one energy source directed at a space between the exit orifice and the stage or at the stage.

2. The printer of claim 1, wherein the energy source includes a photonic source.

3. The printer of claim 1, further comprising a sensor capable of sensing particle condition at a meniscus of a liquid including a particle at the exit orifice.

4. The printer of claim 2, wherein the photonic source includes a laser.

5. The printer of claim 1, further comprising a second printhead.

6. The printer of claim 5, wherein the second printhead is an inkjet printhead.

7. The printer of claim 1, wherein the digital particle ejection printhead includes an array of print nozzles.

8. The printer of claim 1, wherein the stage is a three-dimensional control stage.

9. The printer of claim 1, wherein the stage includes a temperature controller.

10. The printer of claim 1, further comprising a channel for feeding the particles to the meniscus.

11. The printer of claim 1, further comprising a vision system oriented to view at least one of the stage, the printhead, or a flight path of the particle.

12. A method of manufacturing a part comprising:
providing a liquid including a particle to an exit orifice;
sensing a condition at a meniscus of the liquid at the orifice;
applying an electromagnetic signal near the orifice for timed particle ejection based on the sensed condition to deliver the particle to a surface from the orifice after applying the electromagnetic signal; and
applying energy to the particle in flight and prior to delivery of the particle to the surface or upon delivery of the particle at the surface.

13. The method of claim 12, wherein the applied energy is heat.

14. The method of claim 12, wherein the applied energy melts the particle in flight.

15. The method of claim 14, wherein the melted particle solidifies once delivered to the surface.

16. The method of claim 12, wherein the part includes a metal, ceramic or polymer.

17. The method of claim 12, further comprising selecting the structure and composition of the part by selecting a size of the particle, material of the particle and the energy applied to the particle.

18. The method of claim 12, further comprising applying a material to the surface from a second printhead.

19. The method of claim 17, wherein the particle is a metal, a ceramic, or a glass and the material is a metal, a ceramic, a glass, or a plastic.

20. The method of claim 12, wherein the particle is at least a portion of the manufactured part.

21. The method of claim 17, wherein the part is a two-dimensional part or a three dimensional part.

22. A printer comprising:
a digital particle ejection printhead including an orifice;
a sensor capable of sensing particle condition at a meniscus of a liquid including a particle at the exit orifice;
an electromagnetic supply configured to generate an electromagnetic field near the exit orifice to eject the particle through the exit orifice; and
a stage opposite the exit orifice for building a part from the particle.

23. The printer of claim 22, wherein the second printhead is an inkjet printhead.

24. The printer of claim 22, further comprising a second printhead oriented to deposit a material on the stage.

25. The printer of claim 22, wherein the stage is a three-dimensional control stage.

26. The printer of claim 22, wherein the stage includes a temperature controller.

27. The printer of claim 22, further comprising a vision system oriented to view the stage.

28. A method of manufacturing a part comprising:
providing a liquid including a particle to an exit orifice;
sensing a condition at a meniscus of the liquid at the orifice;
applying an electromagnetic signal near the orifice for timed particle ejection based on the sensed condition to deliver the particle to a surface from the orifice after applying the electromagnetic signal; and
applying a material to the surface from a second printhead.

29. The method of claim 28, wherein the particle is a pharmaceutical particle.

30. The method of claim 29, wherein the material is a pharmaceutical additive.

31. The method of claim 28, further comprising selecting a shape of the part.

32. The method of claim 28, wherein the part is a drug product.

33. The method of claim 28, wherein the second printhead is an inkjet printhead.

34. The method of claim 28, wherein the stage comprises a powder bed.

35. The method of claim 28, wherein the second printhead comprises a laser that applies energy to the stage.
